(19) United States
(12) Patent Application Publication
(10) Pub. No.: US 2013/0140868 A1
(43) Pub. Date: Jun. 6, 2013

(54) DISCONTINUOUS SECTION TOWER TUBE

(71) Applicants: Todd Rupert Muck, Fowlerville, MI (US); Peter James Moegling, Brighton, MI (US); Robert Joseph Hazlewood, Plymouth, MI (US); Masroor Fahim, Canton, MI (US)

(72) Inventors: Todd Rupert Muck, Fowlerville, MI (US); Peter James Moegling, Brighton, MI (US); Robert Joseph Hazlewood, Plymouth, MI (US); Masroor Fahim, Canton, MI (US)

(73) Assignee: Toyota Motor Engineering & Manufacturing North America, Inc., Erlanger, KY (US)

(21) Appl. No.: 13/308,956

(22) Filed: Dec. 1, 2011

(51) Int. Cl. B60N 2/68; B23K 26/00; B23K 31/02

(52) U.S. Cl. 297/452.2; 228/173.4; 219/121.85

(57) ABSTRACT

A belt integrated seat tower for a seat system. The seat tower can include a single piece of bent sheet metal in the form of an elongated discontinuous section tube having a first longitudinal edge and a second longitudinal edge adjacent to the first longitudinal edge. A butt weld can join the first and second longitudinal edges to form a lapless seam and a generally flat weld surface.

### FIELD OF THE INVENTION

The disclosure is directed to a belt integrated seat tower and, in particular, a belt integrated seat tower having an elongated discontinuous section tube made from a single piece of sheet metal.

### BACKGROUND OF THE INVENTION

Various types of seating and seating assemblies within motor vehicles are known. Such seat assemblies typically have a supporting frame in combination with seat cushioning, fabric, and the like. Some vehicles include a backseat, second row seat. Third row seat and the like in the form of a 60/40 configuration. A 60/40 seat configuration is known to include a first section that includes a side seat and a second section that includes a center seat. The side seat and/or center seat is typically operable to pivot forward and backward for adjustment.

Heretofore seat assemblies have used seat back side rail members that are made from two separate channel members joined to each other. In most instances, the two separate channel members used to form a seat tower tube are welded together to form a rigid member. However, welding of the two channel members to each other can cause warping and distortion of the seat tower tube that must be straightened before assembly with the remaining seat structure. In addition, welding of the two channel members to each other requires weld metal, welding machinery, and the like. All of such materials and machinery can add to the time and cost for fabrication of the seat and thus of the vehicle. As such, a seat tower tube that minimizes the amount of welding required for its fabrication and yet provides a rigid member would be desirable.

### SUMMARY OF THE INVENTION

A belt integrated seat tower for a seat system is provided. The seat tower can include a single piece of sheet metal that is bent to form an elongated discontinuous section tube having a first longitudinal edge and a second longitudinal edge adjacent to the first longitudinal edge. A butt weld can join the first and second longitudinal edges to form a lapless seam and a generally flat weld surface.

The elongated discontinuous section tube has a bottom end with a bottom polygonal transverse cross-section and a top end with a top polygonal transverse cross-section, the bottom polygonal cross-section being larger than the top polygonal transverse cross-section. In some instances, the bottom and top polygonal cross-sections are rectangular-shaped cross-sections.

A recliner joint bracket can be attached to the bottom end of the elongated discontinuous section tube and be fitted or joined flush up against the generally flat weld surface. In addition, a seat belt retractor bracket can be attached to the top end of the discontinuous section tube and also be fitted or joined flush up against the generally flat weld surface. The recliner joint bracket and/or the seat belt retractor bracket can be adjustable and/or attached to the elongated discontinuous section tube at different locations such that an overall length of the belt integrated seat tower can vary and the elongated discontinuous section tube can be used for different seat models.

A process for making the belt integrated seat tower is also provided and can include providing a single piece of sheet metal having a length, a width, a pair of length edges, and a pair of width edges. The piece of sheet metal has a bottom end portion with a first width and a top end portion with a second width, the first width being greater than the second width. The single piece of sheet metal can be broken along the length to form an elongated tube with the pair of length edges being adjacent to and oppositely disposed from each other such that a butt joint is formed therebetween. The butt joint is butt welded such that the pair of length edges are joined together to form a lapless seam and the welded surface is generally flat such that a separate component can be fitted or attached flat up against the welded surface. In some instances, the butt welding can be performed by laser welding and a recliner joint bracket can be attached to the bottom end of the elongated discontinuous section tube and a seat belt retractor bracket can be attached to the top end. Both the recliner joint bracket and the seat belt retractor bracket can be attached to and fit flush against the weld surface.

### BRIEF DESCRIPTION OF THE DRAWINGS

FIG. 1 is a schematic illustration of a prior art seat frame assembly;

FIG. 2 is an end cross-sectional view of section 2-2 in FIG. 1;

FIG. 3 is an end cross-sectional view of section 3-3 in FIG. 1;

FIG. 4 is an end cross-sectional view of section 4-4 in FIG. 1;

FIG. 5 is a schematic illustration of a flat piece of sheet metal and s series of bends used to make an elongated discontinuous section tube according to an embodiment of the present invention;

FIG. 6 is a perspective view of an elongated discontinuous section tube made from the piece of sheet metal shown in FIG. 5;

FIG. 7 is a perspective view of the elongated discontinuous section tube shown in FIG. 6 with a recliner joint bracket and a seat belt retractor bracket attached thereto; and

FIG. 8 is a perspective view of a seat support assembly that has a belt integrated seat tower with an elongated discontinuous section tube according to an embodiment of the present invention.

### DETAILED DESCRIPTION OF THE INVENTION

A belt integrated seat tower having an elongated discontinuous section tube made from a single piece of sheet metal is provided. As such, the belt integrated seat tower has utility as a component of a seat within a motor vehicle.

The belt integrated seat tower can include a single piece of sheet metal that is bent to form an elongated discontinuous section tube that has a first longitudinal edge and a second longitudinal edge adjacent to the first longitudinal edge. A butt weld can adjoin the first and second longitudinal edges such that a lapless seam and a generally flat weld surface along a transverse section of the tube are formed. For the purposes of the present invention, the term “discontinuous section tube” refers to a tube that has a different transverse cross-sectional area along the length of the tube. Stated differently, a discontinuous section tube does not have a uniform or constant transverse cross-sectional area or circumference along the entire length of the tube.

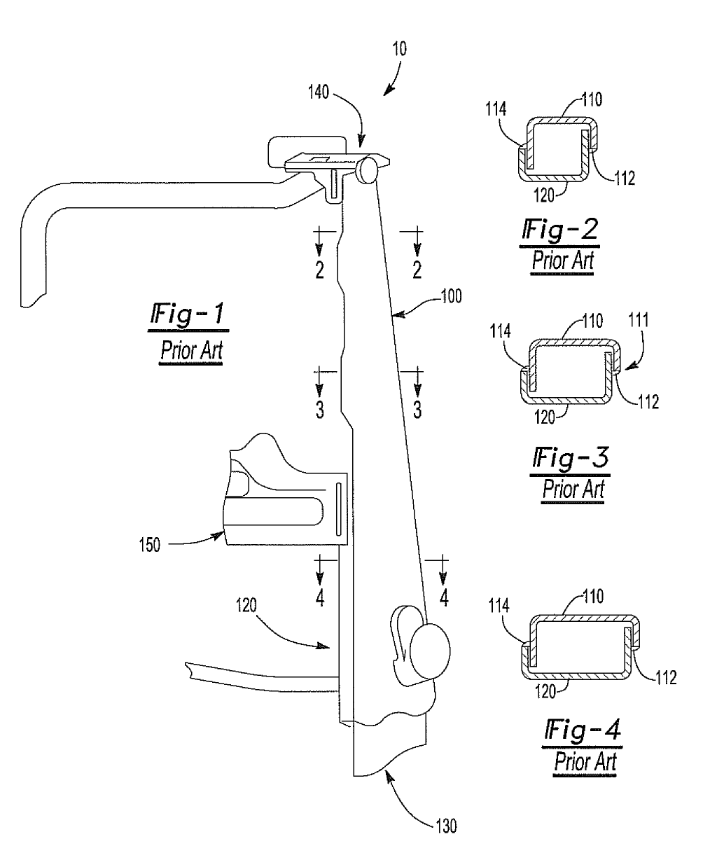

Referring to FIG. 1, a prior art discontinuous section tube is shown as part of a seat support assembly 10. The seat support assembly 10 includes a discontinuous section tube 100 that is made from a first channeled section 110 and a second channeled section 120. The seat assembly 10 can further include a recliner joint bracket 130 attached at a bottom end of the tube 100 and a seat belt guide 140 attached at a top end. A seat belt retractor support 150 can be attached to a back side of the elongated discontinuous section tube 100 with a seat belt retractor (not shown) known to those skilled in the art attached thereto.

As shown by the cross-sectional sections shown in FIGS. 2-4, the first channel member 110 is welded to the second channel member 120 with welds 112 and 114. While such a structure can provide sufficient support for a seat assembly, the welds 112 and 114 require additional material to be added to the structure and may result in distortion and/or warpage of the tube 100. Naturally such distortion and/or warpage must be removed before the tube 100 can be assembled as part of the seat support structure 10, all of which takes additional time, labor, and cost. In addition, a lap joint is formed between the first channel member 110 and second channel member 120 at the locations of welds 112 and 114. It is appreciated that the lap joints prevent a flat surface from being present across an entire surface 111 and thus a separate component can not fit flush up against the entire surface 111. It is also appreciated that such lap joint surfaces can restrict design options, separate component attachment options and the like for a seat frame assembly.

The seat tower disclosed herein provides an elongated discontinuous section tube that is made from a single piece of sheet metal that is bent to form a polygonal transverse cross-section tube that has a single butt seam between elongated edges of the tube. The butt joint can be butt welded, for example using laser welding, such that a generally flat surface is provided across the weld surface and without the presence of a lap joint. In this manner, a single weld along the longitudinal direction of the discontinuous section tube replaces two lap joint welds and thereby reduces and/or eliminates excess material, distortion, and/or warpage. In addition, the elongated discontinuous section tube has sufficient strength such that a seat belt retractor bracket can be attached to a top end and thus allow for the elimination of a cross bracket attached to a back side of the tower. Elimination of the cross bracket, in combination with placement of the seat belt retractor bracket at a top end of the tube, provides improved comfort for an individual that is sitting on a seat that includes the inventive elongated discontinuous section tube.

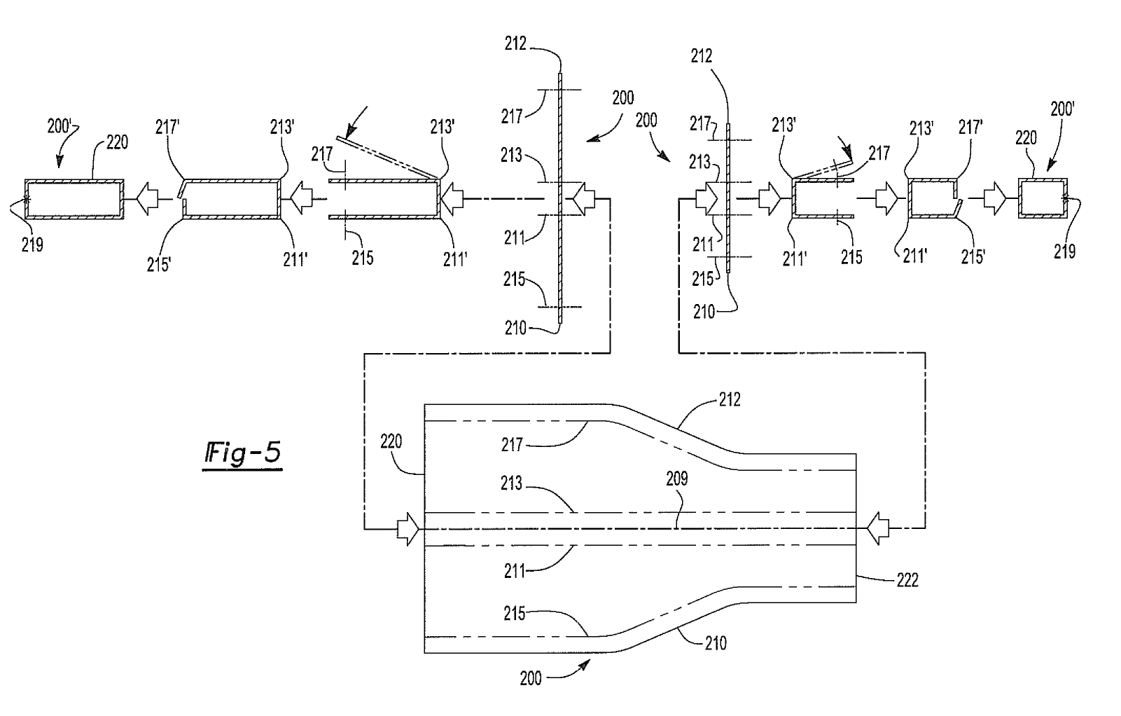

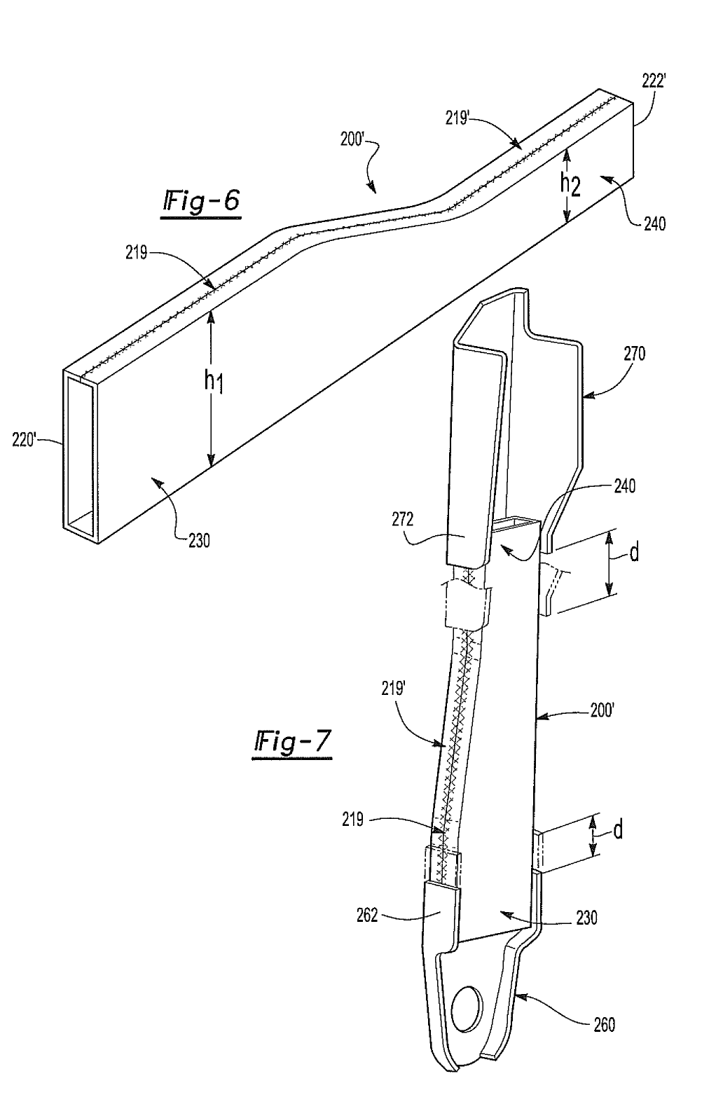

Turning now to FIG. 5, a flat piece of sheet metal 200 that can be used to produce an inventive elongated discontinuous section tube is shown. The piece of sheet metal 200 can have a first longitudinal edge 210 and a second longitudinal edge 212, in addition to a first width edge 220 and a second width edge 222. Spaced inwardly from the first longitudinal edge 210 and the second longitudinal edge 212 can be a pair of first break lines 211, 213 and a pair of second break lines 215, 217. For the purposes of the present invention, the term “break lines” refers to lines along which the material is broken or bent, for example with the use of a sheet metal breaking machine, a die and/or a anvil as is known to those skilled in the art.

FIG. 5 also illustrates an end view of the piece of sheet metal 200 after it has been broken along the first pair of break lines 211, 213 and the second pair of break lines 215, 217. As shown in the figure, the end containing the first width edge 220 has a larger cross-sectional area or circumference than the end containing the second width edge 222. Naturally this is the case since the first width edge 220 is greater than the second width edge 222, the first pair of break lines 211, 213 are equidistance from a center line 209 and the second pair of break lines 215, 217 are spaced equally inward from the first and second longitudinal edges 210, 212.

FIG. 6 provides a perspective view of an elongated discontinuous section tube 200′ provided by breaking the piece of sheet metal 200 along the first pair of break lines 211, 213 and the second pair of break lines 215, 217 as illustrated in FIG. 5. As can be seen from FIG. 6, the elongated discontinuous section tube 200′ has a large end 230 and a small end 240 with a butt seam or joint 219 extending along the length of the tube.

In some instances, the butt joint 219 can be welded using laser welding and any other welding process that affords a generally flat weld surface 219′. In the alternative, the butt joint 219 can be welded such that a weld bead is present and is then subsequently removed, for example by grinding. In any event, the weld surface 219′ is generally flat across its width and length and the butt joint reduces the amount of welding required, warping, etc., when compared to the welded lap joints of prior art tower tubes.

FIG. 6 also illustrates that the discontinuous section tube 200′ has at least one break along the length of the weld surface 219′ which affords for the different heights h₁ versus h₂ for the two different tube ends 230 and 240, respectively.

FIG. 7 provides a perspective view of the elongated discontinuous section tube 200′ along with a recliner joint bracket 260 attached to the large end 230 and a seat belt retractor bracket 270 attached to the small end 240. As illustrated in the figure, the large end 230 can be a bottom end and the small end 240 can be a top end, however this is not required. As shown in the figure, the recliner joint bracket 260 and seat belt retractor bracket 270 fit flush up against the weld surface 219′, something not possible with the tower shown in FIG. 1.

The generally flat weld surface 219′ and uniform dimensions of the large end 230 and/or small end 240 also afford for the recliner joint bracket 260 and/or seat belt retractor bracket 270 to be attached at a different location along the length of the tube 200′. In this manner a single type or design of the tube 200′ can be used for or in different seat models by simply attaching a recliner joint bracket and/or seat belt retractor bracket at different locations on the tube. In the alternative, different recliner joint brackets and/or seat belt retractor brackets can be used for different seat models while using a single type or design of the tube 200′.

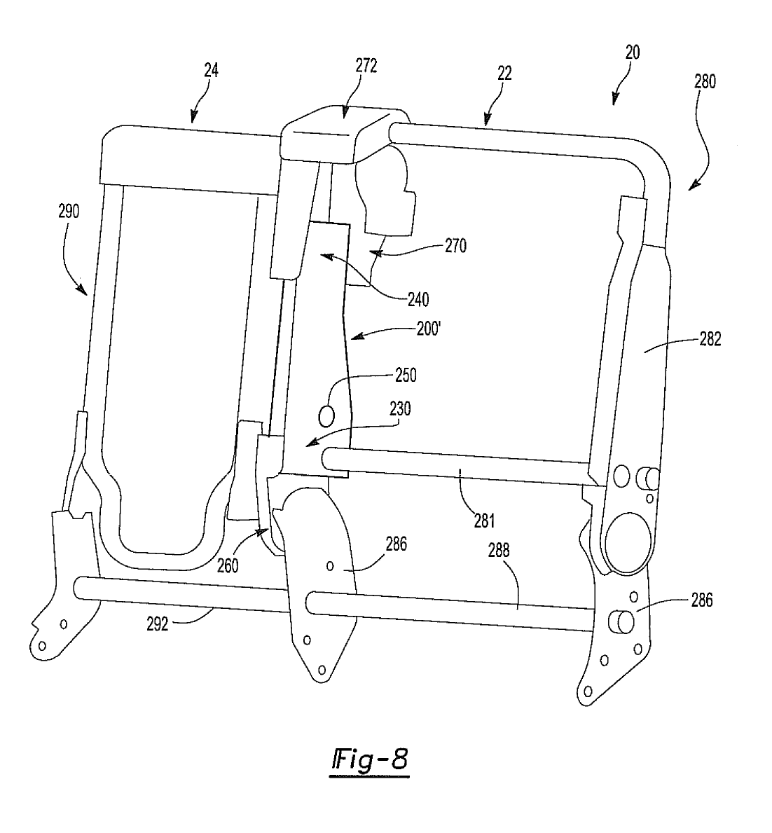

Turning now to FIG. 8, the elongated discontinuous section tube 200′ is shown as part of a seat support structure 20. The tube 200′ with the recliner joint bracket 260 and seat belt retractor bracket 270 attached thereto further includes a cross tube 281 adjoined to a side tower member 282. Other cross members 288 in combination with base brackets 286 and support wire (not shown) can be included to provide a complete seat support structure as is known to those skilled in the art. The seat assembly 20 can be part of a 60/40 seat assembly with the tube 200′ being located between a side seat 22 and a middle seat 24. In addition, placement of the seat belt retractor at the top end 240 of the tube 200′ can result in a more uniform and comfortable seat back for the seat 22.

It is appreciated that the above discussion with respect to the various embodiments, examples, etc. is for illustrative purposes only and is not meant to limit the scope of the invention in any way. Changes, modifications, additions, deletions, and the like to the embodiments, examples, etc. can fall within the scope and spirit of the invention when an elongated discontinuous section tube made from a single piece of sheet metal without the presence of any lap joints is included. As such, the scope of the invention is provided by the claims.

We claim:

1. A belt integrated seat tower comprising:
a single piece of sheet metal bent to form an elongated discontinuous section tube having a first longitudinal edge and a second longitudinal edge adjacent said first longitudinal edge;
a butt weld adjoining said first longitudinal edge to said second longitudinal edge to form a lapless seam and a generally flat weld surface.

2. The belt integrated seat tower of claim 1, wherein said elongated discontinuous section tube has a bottom end with a bottom polygonal transverse cross-section and a top end with a top polygonal transverse cross-section, said bottom polygonal transverse cross-section being larger than said top polygonal transverse cross-section.

3. The belt integrated seat tower of claim 2, wherein said bottom polygonal transverse cross-section and said top polygonal transverse cross-section are rectangular transverse cross-sections.

4. The belt integrated seat tower of claim 2, further comprising a recliner joint bracket attached to said bottom end and flush against said generally flat weld surface.

5. The belt integrated seat tower of claim 4, further comprising a seat belt retractor bracket attached to said top end and flush against said generally flat weld surface.

6. The belt integrated seat tower of claim 5, wherein attachment of said recliner joint bracket to said bottom end is adjustable, for the purpose of using said elongated discontinuous section tube in different motor vehicle models.

7. The belt integrated seat tower of claim 5, wherein attachment of said seat belt retractor bracket to said top end is adjustable, for the purpose of using said elongated discontinuous section tube in different motor vehicle models.

8. A seat for a motor vehicle having a belt integrated seat tower of claim 1.

9. The seat of claim 8, wherein said seat is a 60/40 rear seat for the motor vehicle.

10. A process for making a belt integrated seat tower, the process comprising:
providing a single piece of sheet metal having a length, a width, a pair of length edges and a pair of width edges, the width having a bottom end portion with a first width and a top end portion with a second width, the first width being greater than the second width;
breaking the single piece of sheet metal along the length to form an elongated tube with the pair of length edges adjacent to oppositely disposed from each other and forming a butt joint;
butt welding the butt joint such that the pair of length edges are joined together to form a lapless seam and the welded surface is generally flat along a transverse direction and an elongated discontinuous section tube is formed;
the elongated discontinuous section tube having a bottom end with a bottom polygonal transverse cross-section and a top end with a top polygonal transverse cross-section that is smaller than the bottom polygonal transverse cross-section.

11. The process of claim 10, wherein the bottom polygonal transverse cross-section and top polygonal transverse cross-section are rectangular.

12. The process of claim 10, wherein the butt welding is performed by laser welding.

13. The process of claim 10, further including attaching a recliner joint bracket to the bottom end of the elongated discontinuous section tube.

14. The process of claim 13, further including attaching a seat belt retractor bracket to the top end of the elongated discontinuous section tube.

15. The process of claim 14, wherein attachment of the recliner joint bracket to the bottom end is adjustable, for the purpose of using the elongated discontinuous section tube in different motor vehicle models.

16. The process of claim 14, wherein attachment of the seat belt retractor bracket to the top end is adjustable, for the purpose of using the elongated discontinuous section tube in different motor vehicle models.
